(19) United States
(12) Patent Application Publication
(10) Pub. No.: US 2008/0123607 A1
(43) Pub. Date: May 29, 2008

(54) 802.11K NEIGHBOR REPORT ENHANCEMENT

(75) Inventor: Jari Jokela, Ylojarvi (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/942,580

(22) Filed: Nov. 19, 2007

Related U.S. Application Data
(63) Continuation of application No. 11/697,237, filed on Apr. 5, 2007, now abandoned.
(60) Provisional application No. 60/790,126, filed on Apr. 7, 2006.

(51) Int. Cl. H04Q 7/24; H04Q 7/20

(52) U.S. Cl. 370/338; 455/432.1

(57) ABSTRACT

The enhancement of a neighbor report to include additional information about neighboring access point capabilities. The present invention involves having neighbor reports include information that helps a station to determine whether admission control is mandated by one or more neighboring access points. The present invention can simply be added to the current 802. 11 standards, as existing information elements are used for implementation.

### CROSS-REFERENCE TO RELATED PATENT APPLICATIONS

This application claims priority from Provisional Application U.S. Application 60/790,126, filed Apr. 7, 2006, incorporated herein by reference in its entirety. The present application is also a continuation of U.S. patent application Ser. No. 11/697,237, filed Apr. 5, 2007, titled 802.11K NEIGHBOR REPORT ENHANCEMENT, which is hereby incorporated by reference in its entirety and for all purposes.

### FIELD OF THE INVENTION

The present invention relates to networks constructed in accordance with the Institute of Electrical & Electronics Engineers (IEEE) 802.11 standard. More particularly, the present invention relates to the use of neighbor reports in IEEE 802.11 networks.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A neighbor report may be used in aiding roaming stations to obtain information about neighboring access points (APs). A neighbor report is sent by an AP and contains information on known neighbor APs. A neighbor report may not be exhaustive either by choice or due to the fact that there may be neighbor APs not known to the AP transmitting the report.

The purpose of the neighbor report is to enable a station to optimize aspects of neighbor basic service set (BSS) transition and extended service set (ESS) operation. A neighbor report element contains information on APs which the station may use as candidates for a BSS transition. A neighbor report element only contains entries for validated neighbor APs that are members of ESSs requested in the neighbor report Request.

An associated station requesting a neighbor report sends a neighbor report Request frame to its associated AP. An AP accepting a neighbor report Request responds with a neighbor report Response frame. If there are no list entries available, the AP sends a neighbor report Response with no Neighbor List Entries.

An AP receiving a neighbor report Request responds with a neighbor report Response frame containing zero or more neighbor report elements. If service set identification (SSID) elements are specified in the corresponding neighbor report Request frame and are different than the current ESS, then information related to the current ESS AP's are not included, in which case only information relating to the requested SSID is reported back. If the SSID element is omitted, the neighbor report element contains information concerning neighbor APs that belong to the same ESS as the requesting station. If there are no list entries available, the AP sends a neighbor report Response with no Neighbor List Entries.

A serving AP includes a synchronization function (TSF) Offset field in the Neighbor List Entry only if it is able to guarantee an accumulated error of ±1.5 TU or better on the TSF Offset subfield. The error budget (±1.5 TU) can be broken down as follows:
Delays by the measuring station in transmitting the first bit of the Beacon Report after receiving the last bit of a neighbor AP's Beacon or Probe Response (±0.5 TU).
Error caused by rounding to the nearest TU boundary when converting Neighbor TSF Offset from microseconds to TUs (±0.5 TU).

Delays by the serving AP between reception of the last bit of the Beacon Report and transmission of the first bit of the neighbor report (±0.5 TU).

FIG. 1 shows the neighbor report element format according to the current 802.11k standard. According to current the 802.11k standard, the Element ID field is equal to 52. The value of Length field is dependent upon the number of Neighbor List Entries representing the neighboring APs being reported. Each entry describes an AP and includes BSSID, BSSID Information, Channel Number, Regulatory Class, PHY Options, and optionally may include the TSF offset fields. The minimum value of the Length field is 0 (i.e., with no neighbor APs in the neighbor report element).

The Neighbor List comprises of zero or more Neighbor List Entries. FIG. 2 shows the neighbor list entry format in the current 802.11k standard. The BSSID in FIG. 2 is the BSSID of the BSS being reported. The subsequent fields in the Neighbor List Entry pertain to this BSS. The BSSID Information field may be used to help determine neighbor BSS transition candidates. FIG. 3 is a representation of a conventional BSSID information field. The AP reachability field indicates whether the AP identified by this BSSID is reachable by the station that requested the Neighbor Report for the exchange of preauthentication frames. The values are shown in Table 1 as follows.

TABLE 1
Reachability Field Values

| Value | Reachability | Usage |
|---|---|---|
| 0 | Reserved | n/a |
| 1 | Not Reachable | A station sending a preauthentication |
| | | frame to the BSSID will not receive a |
| | | response even if the AP represented |
| | | by the BSSID is capable of |
| | | preauthentication. |
| 2 | Unknown | The AP is unable to determine if the |
| | | value Reachable or Not Reachable is |
| | | to be returned. |
| 3 | Reachable | The station sending a |
| | | preauthentication frame to the BSSID |
| | | can receive a response from an AP |
| | | that is capable of preauthentication. |

The Security bit, if set, indicates that the AP identified by this BSSID supports all of the security capabilities of the AP with which the station is currently associated. If the bit is not set, it indicates that either the capabilities do not match or the information is not available to the AP at this time. The Key Scope bit, when set, indicates the AP represented by this BSSID has the same authenticator as the AP sending the report. If this bit is not set, it indicates a distinct authenticator or the information is not available.

The Capabilities Subfield contains selected capability information for the AP represented by this BSSID. The bit fields within this subfield shall have the same meaning and be set equal to the equivalent bits within the Capability Information field being sent in the beacons by the AP being reported. The format of the Capabilities subfield is as in FIG. 4.

Bits 10-15 are reserved and are set to 0 on transmission and ignored on reception. The Channel Number indicates the current operating channel of the AP represented by the BSSID in this neighbor list entry. The Regulatory Class contains an enumerated value specifying the frequency band in which the Current Channel is valid. The PHY Options field contains the Condensed PHY type and TSF offset Flag as shown in the FIG. 5.

The Condensed PHY Type indicates the PHY type of the AP being reported. It has an integer value between 0 and 127. The TSF offset Flag is a one bit field. When it is set to 1, it indicates that a TSF offset field is present for this Neighbor List Entry. When set to 0, it indicates that a TSF offset field is not present for this Neighbor List Entry. The Neighbor Report may have the TSF offset Flag set in some Neighbor List Entries and not set in others. The TSF offset is 4 octets long and contains TSF Offset and Beacon Interval subfields.

The TSF Offset subfield is 2 octets long and contains the neighbor AP's TSF timer offset. The TSF offset field format is depicted in FIG. 6. This is the time difference, in TU units, between the serving AP and a neighbor AP. This offset is given modulo the neighbor AP's Beacon Interval and rounded to the nearest TU boundary. The Beacon Interval field is the beacon interval of the Neighbor AP being reported.

Roaming enhancements are currently being defined for the IEEE 802.11r standard. Part of the enhancements involves a resource reservation system prior to actual association to a new AP. In the case of fast roaming, resource reservation is beneficial if (1) the new AP is 802.11e capable (i.e., it is a QoS Access Point (QAP)) and (2) the new AP is using admission control. In these cases, the station can use traffic specification (TSPEC) signaling to reserve resources prior to actual transition to the new AP. However, such a system is somewhat deficient in that the station will not know whether the new AP supports the above-mentioned functionalities unless it either passively or actively scans the environment. This is non-optimal from a capacity and power save point of view. In the case of passive scanning, this problem can be quite severe, as the required information (EDCA Parameter Set) may not be included in all of the Beacon frames.

### SUMMARY OF THE INVENTION

The present invention involves the enhancement of the neighbor report defined in 802.11k to include additional information about neighboring AP capabilities. More particularly, the present invention involves having neighbor reports include information that helps a station to determine whether admission control is mandated by one or more neighboring access points. Currently, the neighbor report includes information regarding whether the AP is a QAP or not, but it does not include information regarding whether admission control is supported or mandated.

The present invention addresses this issue. In addition to allowing a terminal to decide whether pre-reservation should be used, the present invention has a number of other advantages. The present invention can simply be added to the current 802.11 standards, as existing information elements are used for implementation. Additionally, an EDCA Parameter Set can be obtained by using Beacon Measurement.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of the neighbor report element format for the current IEEE 802.11k standard;

FIG. 2 is a depiction of the neighbor list entry format for the current IEEE 802.11k standard;

FIG. 3 is a depiction of the BSSID Information field format under the current IEEE 802.11k standard;

FIG. 4 is a depiction of the Capabilities Subfield format under the current IEEE 802.11k standard;

FIG. 5 is a depiction of the PHY Options field format under the current IEEE 802.11k standard;

FIG. 6 is a depiction of the TSF Offset field format under the current IEEE 802.11k standard;

FIG. 7 is a depiction of the QoS Info field containing the EDCA Parameter SetUpdate count;

FIG. 8 is a representation of a wireless network in which the present invention may be implemented;

FIG. 9 is an overview diagram of a more general system within which the present invention may be implemented;

FIG. 10 is a perspective view of a mobile telephone that can be used in the implementation of the present invention;

FIG. 11 is a schematic representation of the telephone circuitry of the mobile telephone of FIG. 10.

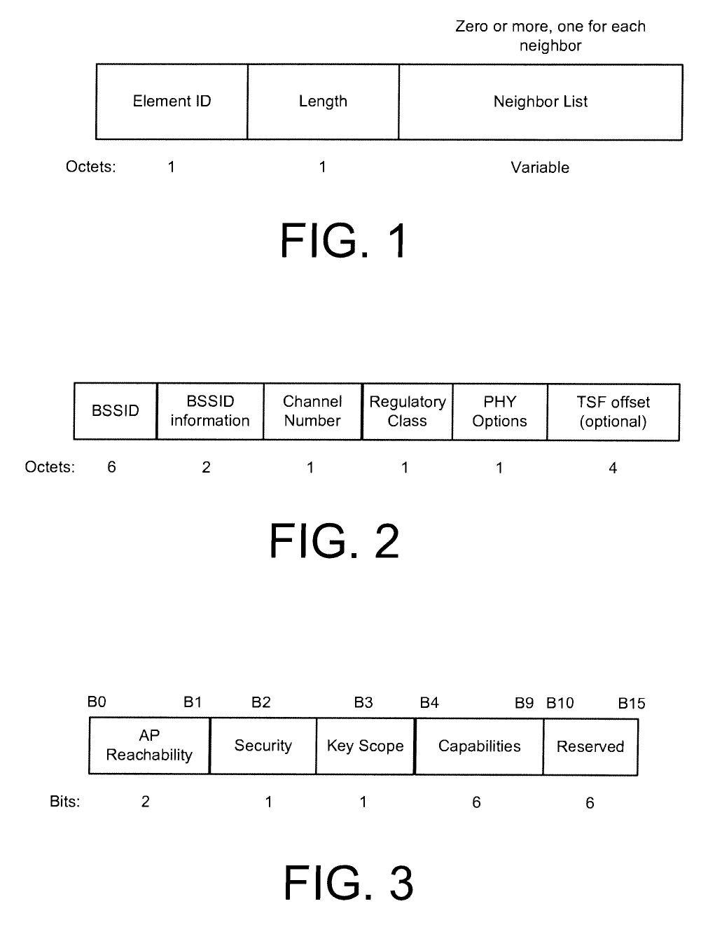

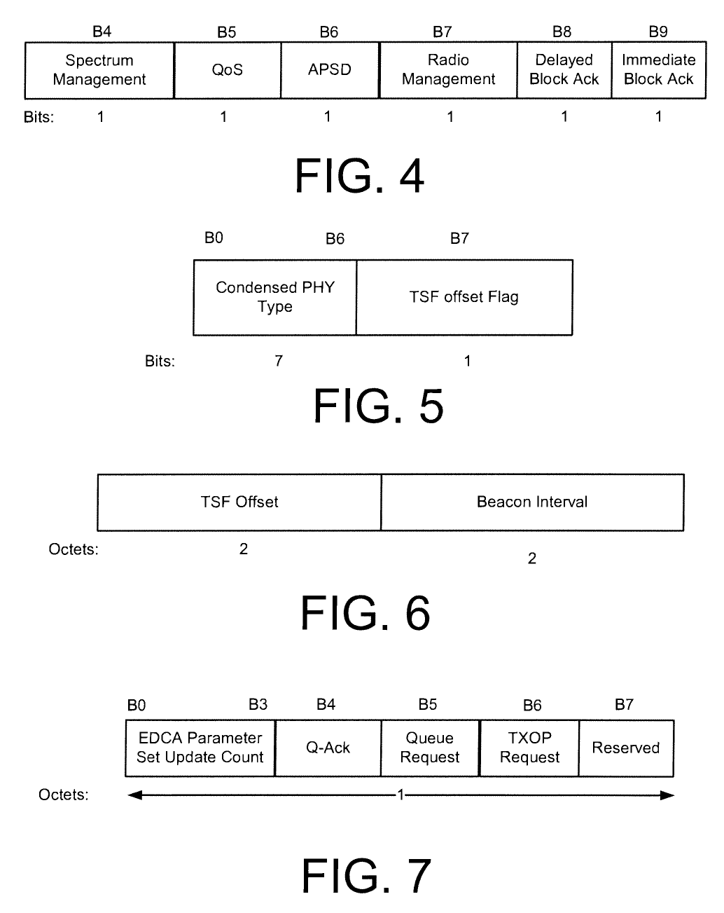

### DETAILED DESCRIPTION OF THE PREFERRED EMBODIMENTS

The present invention involves the enhancement of the neighbor report defined in 802.11k to include additional information about neighboring AP capabilities. More particularly, the present invention involves having neighbor reports include information that helps a station to decide whether pre-reservation is rational. Currently, the neighbor report includes information regarding whether the AP is a QAP or not, but it does not include information regarding whether admission control is supported.

The present invention applies to wireless systems where information about nearby access points is provided to the stations operating in the network. The information is based on neighborhood measurements and can be provided to the station requesting such neighborhood/nearby access point information by neighborhood report messages. The present invention helps the station to identify that the neighboring AP or APs are such that it can make a handover to them and still maintain its connections.

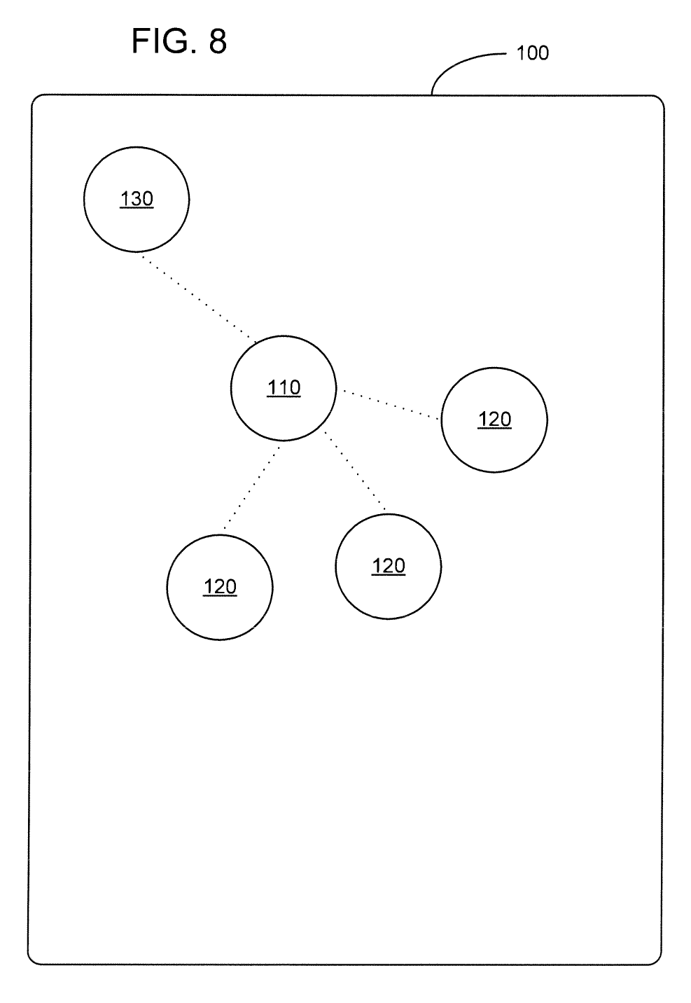

FIG. 8 shows a sample network 100, such as an IEEE 802.11 network, within which the present invention may be implemented. The network 100 includes a roaming electronic device 110 that first communicates with a serving AP 110. At an initial point, the serving AP 110 is communicatively connected with a plurality of neighbor APs 120.

In one embodiment of the present invention, in order to indicate whether a neighbor AP supports (and is using) admission control, an Enhanced Distributed Channel Access (EDCA) Parameter Set (defined in 802.11e) element is added to the neighbor report. The EDCA Parameter Set element provides information needed by non-AP QoS stations (QSTAs) for proper operation of the QoS facility during the contention period. The EDCA Parameter Set element is used by the QAP to establish policy (by changing default MIB attribute values), to change policies when accepting new stations or new traffic, or to adapt to changes in offered load. The most recent EDCA parameter set element received by a non-AP QSTA is used to update the appropriate MIB values. FIG. 5 is a representation of a conventional EDCA parameter set element. The QoS Info field, depicted in FIG. 7, contains the EDCA Parameter SetUpdate Count, which is initially set to 0 and is incremented each time any of the AC parameters changes. This field is used by non-AP QSTAs to determine whether the EDCA parameter set has changed and requires updating the appropriate MIB attributes.

The EDCA parameter set can be part of a BSSID information field, with this field being extended to be 22 octets. Adding a full EDCA Parameter Set also serves to provide other valuable information to the terminals. For example, using a full EDCA parameter set results in the channel access parameters also being provided, as channel access parameters are also included in this field.

A second embodiment of the present invention can be useful if a full EDCA parameter set is considered to add too much overhead. In a second embodiment, a four bit field is added to the BSSID information field shown in FIG. 2. Using this four-bit field it is possible to define which access categories are using admission control.

In a third embodiment of the invention, a single bit is used to indicate that a neighbor AP 120 has the same admission control rules as the serving AP 110. This bit can be a bit in the BSSID information field, depicted in FIG. 3 when sent by a QAP, and can be one of the reserved bits in this field.

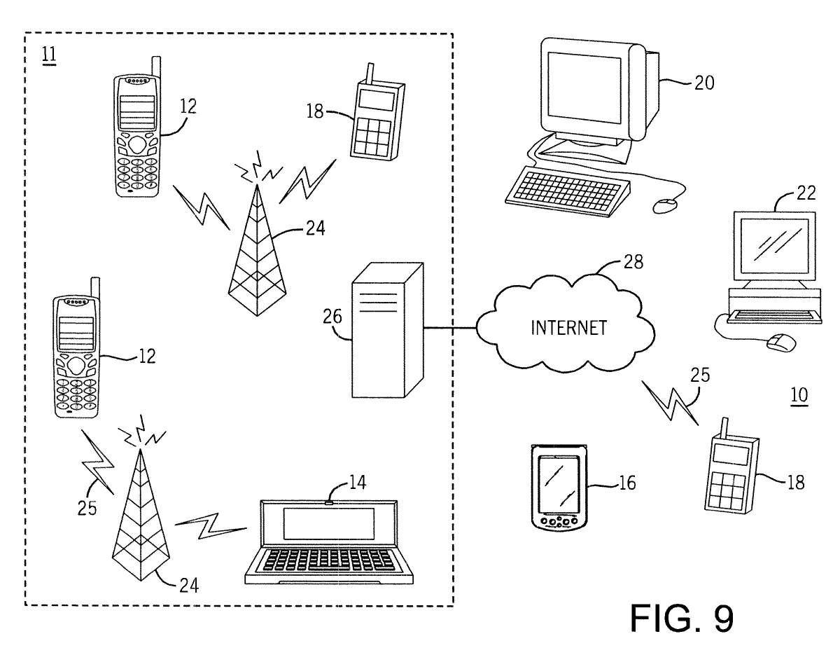

FIG. 9 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 8 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

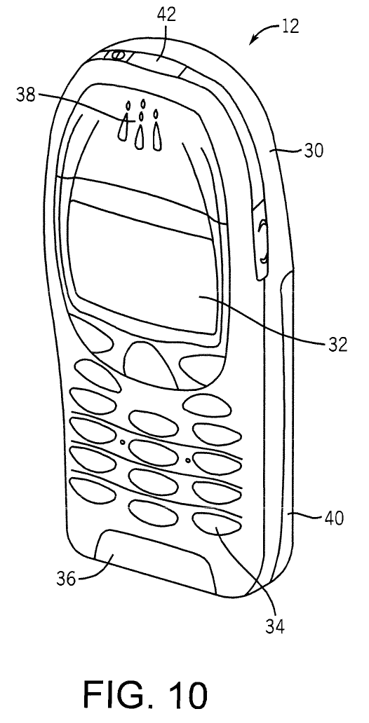

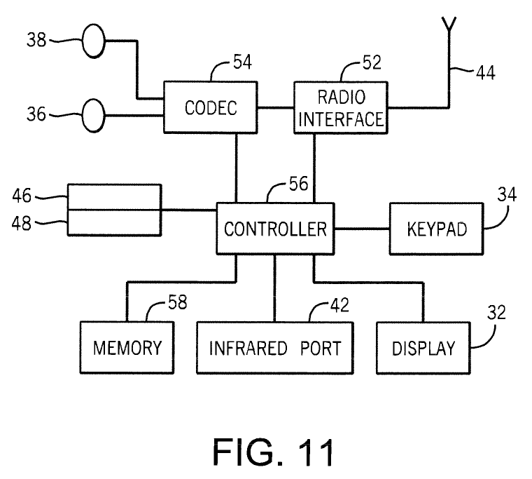

FIGS. 10 and 11 show one representative mobile telephone 12 within which the present invention may be implemented. It should be understood, however, that the present invention is not intended to be limited to one particular type of mobile telephone 12 or other electronic device. The mobile telephone 12 of FIGS. 10 and 11 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of obtaining information regarding devices in a network, comprising:
transmitting a neighbor report request frame to a serving access point within the network; and
receiving a neighbor report response frame from the serving access point in response to the transmitted neighbor report request frame, the neighbor report response frame including information concerning whether admission control is mandated by one or more neighboring access points.

2. The method of claim 1, wherein the information regarding whether admission control is mandated by one or more neighboring access points is included in an Enhanced Distributed Channel Access Parameter Set within the neighbor report response frame.

3. The method of claim 2, wherein the Enhanced Distributed Channel Access Parameter Set is included in a BSSID information field in the neighbor report response frame.

4. The method of claim 1, wherein the neighbor report response frame includes a BSSID information field comprising a four-bit field, the four-bit field being used to define which neighboring access points are using admission control.

5. The method of claim 1, wherein the neighbor report response frame includes a bit of information used to indicate whether the one or more neighboring access points have the same admission rules as the serving access point.

6. A computer program product, included in a computer-readable medium, for obtaining information regarding devices in a network, comprising:
computer code for transmitting a neighbor report request frame to a serving access point within the network; and computer code for receiving a neighbor report response frame from the serving access point in response to the transmitted neighbor report request frame, the neighbor report response frame including information concerning whether admission control is mandated by one or more neighboring access points.

7. The computer program product of claim 6, wherein the information regarding whether admission control is mandated by one or more neighboring access points is included in an Enhanced Distributed Channel Access Parameter Set within the neighbor report response frame.

8. The computer program product of claim 7, wherein the Enhanced Distributed Channel Access Parameter Set is included in a BSSID information field in the neighbor report response frame.

9. The computer program product of claim 6, wherein the neighbor report response frame includes a BSSID information field comprising a four-bit field, the four-bit field being used to define which neighboring access points are using admission control.

10. The computer program product of claim 6, wherein the neighbor report response frame includes a bit of information used to indicate whether the one or more neighboring access points have the same admission rules as the serving access point.

11. An electronic device, comprising
a processor; and
a memory unit communicatively connected to the processor and including:
computer code for transmitting a neighbor report request frame to a serving access point within the network; and
computer code for receiving a neighbor report response frame from the serving access point in response to the transmitted neighbor report request frame, the neighbor report response frame including information concerning whether admission control is mandated by one or more neighboring access points.

12. The electronic device of claim 11, wherein the information regarding whether admission control is mandated by one or more neighboring access points is included in an Enhanced Distributed Channel Access Parameter Set within the neighbor report response frame.

13. The electronic device of claim 12, wherein the Enhanced Distributed Channel Access Parameter Set is included in a BSSID information field in the neighbor report response frame.

14. The electronic device of claim 11, wherein the neighbor report response frame includes a BSSID information field comprising a four-bit field, the four-bit field being used to define which neighboring access points are using admission control.

15. The electronic device of claim 11, wherein the neighbor report response frame includes a bit of information used to indicate whether the one or more neighboring access points have the same admission rules as the serving access point.

16. A method of providing information regarding devices in a network to a roaming device, comprising:
receiving a neighbor report request frame from a roaming device within the network; and
transmitting a neighbor report response frame to the roaming device in response to the transmitted neighbor report request frame, the neighbor report response frame including information concerning whether admission control is mandated by one or more neighboring access points.

17. The method of claim 16, wherein the information regarding whether admission control is mandated by one or more neighboring access points is included in an Enhanced Distributed Channel Access Parameter Set within the neighbor report response frame.

18. The method of claim 17, wherein the Enhanced Distributed Channel Access Parameter Set is included in a BSSID information field in the neighbor report response frame.

19. The method of claim 16, wherein the neighbor report response frame includes a BSSID information field comprising a four-bit field, the four-bit field being used to define which neighboring access points are using admission control.

20. The method of claim 16, wherein the neighbor report response frame includes a bit of information used to indicate whether the one or more neighboring access points have the same admission rules as a device transmitting the neighbor report response frame.

21. A computer program product, included in a computer-readable medium, for providing information regarding devices in a network to a roaming device, comprising:
computer code for receiving a neighbor report request frame from a roaming device within the network; and
computer code for transmitting a neighbor report response frame to the roaming device in response to the transmitted neighbor report request frame, the neighbor report response frame including information concerning whether admission control is mandated by one or more neighboring access points.

22. An electronic device, comprising
a processor; and
a memory unit communicatively connected to the processor and including:
computer code for receiving a neighbor report request frame from a roaming device within the network; and
computer code for transmitting a neighbor report response frame to the roaming device in response to the transmitted neighbor report request frame, the neighbor report response frame including information concerning whether admission control is mandated by one or more neighboring access points.

23. A system for providing information regarding devices in a network, comprising:
a roaming electronic device including computer code for transmitting a neighbor report request frame;
a serving access point including computer code for receiving the neighbor report request frame; and
at least one neighbor access point communicatively connected to the serving access point,
wherein the serving access point further includes computer code for transmitting a neighbor report response frame to the roaming electronic device in response to the neighbor report request frame, the neighbor report response frame including information concerning whether admission control is mandated by one or more neighboring access points.
